(19) United States
(12) Patent Application Publication
(10) Pub. No.: US 2016/0283307 A1
(43) Pub. Date: Sep. 29, 2016

(54) MONITORING SYSTEM, MONITORING DEVICE, AND TEST DEVICE

(71) Applicant: HITACHI, LTD., Tokyo (JP)

(72) Inventors: Yoshiteru TAKESHIMA, Tokyo (JP); Yukiko TAKEDA, Tokyo (JP); Masahiko NAKAHARA, Tokyo (JP); Seiya KUDO, Tokyo (JP)

(73) Assignee: HITACHI, LTD., Tokyo (JP)

(21) Appl. No.: 15/033,881

(22) PCT Filed: Mar. 18, 2015
(86) PCT No.: PCT/JP2015/058067

§ 371 Date: May 2, 2016

(30) Foreign Application Priority Data
Jul. 28, 2014 (JP) 2014-152599

(51) Int. Cl. G06F 11/07; G06F 11/34; G06F 11/30

(52) U.S. Cl. CPC G06F 11/079; G06F 11/0709; G06F 11/076; G06F 11/0787; G06F 11/3006; G06F 11/3495

(57) ABSTRACT

A monitoring device executes: aggregating a number of messages for each type of message transmitted or received at nodes using test results; classifying the respective messages into either an original message that serves as an origin among messages transmitted and received by a system to be monitored, or a generated message that is generated in the system when the original message is transmitted to any of the plurality of nodes; analyzing a relationship between the original message and the generated message on the basis of a number of messages classified as the original message and a number of messages classified as the generated message, thereby creating a matrix indicating the relationship between the original message and the generated message; and determining that the system has undergone a failure if a value of an element inside the matrix is outside of a normal range.

### CLAIM OF PRIORITY

The present application claims priority from Japanese patent application JP 2014-152599 filed on Jul. 28, 2014 the content of which is hereby incorporated by reference into this application.

### BACKGROUND

The disclosed subject matter relates to a monitoring system that monitors a system to be monitored, a monitoring device, and a test device that tests the system to be monitored.

In recent years, as a result of rapid development in devices such as mobile phones having internet access, various commercial and public services are being provided through communication networks. As the importance of communication networks increases, the impact on society of any failure in network systems, which serve as a base for communication networks, increases in proportion to this importance.

An example of a network system is a packet exchange system for mobile phones. Packet exchange systems are constituted of a group of network nodes (hereinafter, “nodes”), which are devices having various functions. Malfunctions or congestions in such nodes result in it becoming impossible to provide a satisfactory communication service to the end user, that is, such malfunctions or congestions result in communication failure. Thus, such communication failures in network systems need to be detected early.

A standard method for monitoring a system is to use one or more fixed values as a threshold for performance information, such as CPU usage, of the group of servers to be monitored, and considering that an anomaly has occurred when this threshold value has been exceeded. Such a monitoring method is suited to a system constituted primarily of general use PC servers, due to the ease of installation of monitoring software and customization of monitoring settings. On the other hand, many installed network nodes are specialized devices, and in some cases, internal data held by such nodes such as performance information and logs, which are needed for monitoring, cannot be used. One failure detection method for a network system is a technique for detecting anomalies in communication between nodes by measuring the number of packets flowing in the network, or acquiring information pertaining to communication from a network device such as a network switch, and analyzing such information.

An example of a conventional technique for monitoring a network system is disclosed in JP 2005-216066 A. The method disclosed in JP 2005-216066 A (see paragraphs [0019], [0020]) is an anomaly detection system that can withstand dramatic changes in observed values and degrees of correlation, that takes into consideration mutual interdependency of a plurality of observation points in a run time environment, and that automatically detects failures, examples of which primarily include service stoppage at the application level. Specifically, in the anomaly detection system, each computer in the computer system, which forms a network by a plurality of computers, has an agent device that records transactions, which are service processes, in association with the services.

In the anomaly detection system, each agent device transmits transactions to the anomaly monitoring server, and the anomaly monitoring server gathers recorded transactions from the agent devices. Each agent device outputs node correlation matrices generated from the gathered transactions, and calculates activity level vectors by solving equations unique to the node correlation matrices. Each agent device automatically detects anomalies in running programs while the plurality of computers are associated with each other, by calculating the amount of outliers in the activity level vectors from a probability density, which estimates the probability that the activity level vector would be generated from the calculated activity level vector.

### SUMMARY

However, the above-mentioned conventional technique has a problem in that anomaly detection is dependent on the number of nodes, and thus, if the number or configuration of the nodes dynamically changes, then failures are falsely detected in nodes that have not failed, or failure is not detected in nodes that have failed. In a virtual system, for example, the number of virtual nodes increases and IP addresses of virtual nodes change. Thus, if the above conventional technique is used, this can result in false positives or negatives for failure detection.

The present application discloses a technique for reducing false positives or negatives for failure detection regardless of the number or configuration of nodes.

An aspect of the disclosure is a monitoring system comprising: a test device that tests a plurality of messages transmitted and received by nodes in a system to be monitored, the system to be monitored having a plurality of said nodes that can communicate with each other; and a monitoring device that monitors the system to be monitored using test results from the test device.

The monitoring device executes: an aggregation process of aggregating a number of messages for each type of message transmitted or received at the nodes using the test results received from the test device; a classification process of classifying the respective messages, for which the numbers thereof were aggregated by the aggregation process, into either an original message that serves as an origin among messages transmitted and received by the system to be monitored, or a generated message that is generated in the system to be monitored when the original message is transmitted to any of the plurality of nodes; an analysis process of analyzing a relationship between the original message and the generated message on the basis of a number of messages classified by the classification process as the original message and a number of messages classified by the classification process as the generated message, thereby creating a matrix indicating the relationship between the original message and the generated message; and a detection process of determining that the system to be monitored has undergone a failure if a value of an element inside the matrix is outside of a normal range.

If the values of the elements are within the normal range, then if an original message has been inputted to a certain node, the value of the element indicates that a generated message has been generated in another node. On the other hand, if the value of the element is outside the normal range, the value of the element indicates that a communication failure resulting from a software fault or a hardware malfunction has occurred, such as mass deletion, mass copying, or mass resending of messages.

According to the disclosure, false positives or negatives for failure detection can be reduced regardless of the number or configuration of nodes. Details of at least one embodiment of the matter disclosed in the present specification are described with reference to the affixed drawings and in the text below.

Other features, aspects, and advantages of the subject matter will become apparent from the description, the drawings, and the claims.

### BRIEF DESCRIPTION OF THE DRAWINGS

FIG. 1 is a descriptive drawing showing an example of communication state modeling.

FIG. 2 is a descriptive drawing showing an example of a relationship between the sequence of traffic flowing in the network system and the conversion matrix.

FIG. 3 is a block diagram showing a system configuration example for a monitoring system of the present embodiment.

FIG. 4 is a descriptive drawing showing one example of the traffic statistic time-series information.

FIG. 5 is a descriptive drawing showing one example of the traffic relation structure information.

FIG. 6 is a descriptive drawing showing one example of the measurement setting information.

FIG. 7 is a descriptive drawing showing one example of the measurement control information.

FIG. 8 is a block diagram for showing a hardware configuration example of the test device and the monitoring device.

FIG. 9 is a flowchart showing an example of monitoring process steps by the monitoring device.

FIG. 10 is a flow chart showing an example of detailed process steps of the anomaly detection process (step S906) shown in FIG. 9.

FIG. 11 is a flow chart showing an example of detailed internal process steps of the anomaly location identification step (step S907) shown in FIG. 9.

FIG. 12 is a flow chart showing an example of detailed process steps of the measurement control process (step S908) shown in FIG. 9.

### DETAILED DESCRIPTION OF THE EMBODIMENT

The present embodiment proposes a failure detection method that does not depend on the number or configuration of nodes inside the network system. In this manner, even if the number and configuration of nodes changes, nodes that have not failed are not falsely detected as having failed, and nodes that have failed are not falsely detected as not having failed, and thus, the accuracy of failure detection can be improved. If the number of nodes increases, the node correlation matrix increases in size in proportion to the increase in number of nodes, which increases the amount of calculation required. If the amount of calculation required increases, the amount of time needed to detect failures also increases. The present embodiment does not depend on the number of nodes, and thus, reducing an increase in the amount of matrix calculation enables failure to be detected at an early stage. Below, an embodiment will be described.

<Communication State Modeling>

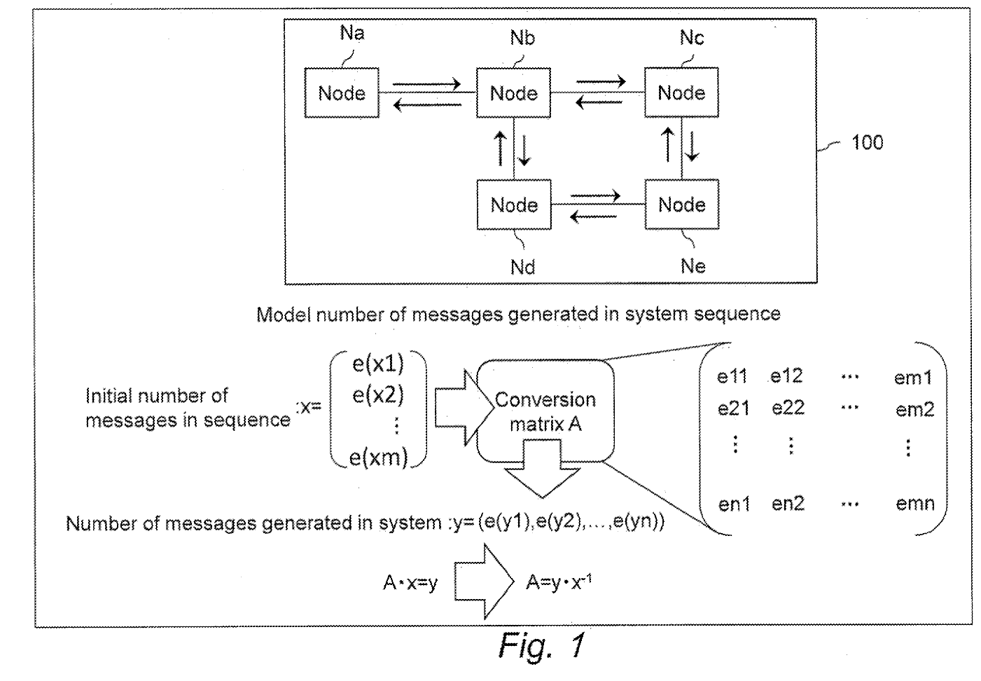

FIG. 1 is a descriptive drawing showing an example of communication state modeling. A network system 100 has a plurality (five in the example of FIG. 1) of nodes Na to Ne (collectively referred to as nodes N below). The node N is a communication device that is connected to other nodes N so as to be able to communicate therewith. If the network system 100 is a long term evolution (LTE) (registered trademark) communication system, for example, then the node Na is an evolved Node B (eNB), the node Nb is a mobility management entity (MME), the node Nc is a home subscriber server (HSS), the node Nd is a serving gateway (SGW), and the node Ne is a packet data network (PDN) gateway (PGW). A plurality of nodes N of the same type may be present. For example, in this embodiment, there is one each of nodes Na to Ne, but a plurality of each may be present.

In the present embodiment, a sensor network system may be used as the network system 100 to be monitored. In such a case, the network system 100 is constituted of a sensor node, a route node, and a gateway node. The sensor node measures such parameters as temperature to be observed according to a command from a server, for example. The route node forwards observed data from the sensor node as well as commands from the server. The gateway node forwards commands from the server to the route node as well as observed data forwarded from the route node to the server.

The following describes how the sequence of traffic flowing inside the network system 100 is modeled. Initial messages x1 to xm of an m number of sequences 1 to m (m being an integer of 1 or greater) are stored as a column vector x. The number of elements e(x1) to e(xm) of the column vector x is equal to the number of initial messages x1 to xm of the sequence 1 to m. Although the initial messages x1 to xm of the sequence 1 to m were used, the configuration is not limited to the initial messages as long as the type of message is specified.

Subsequent messages y1 to yn, which are triggered by the initial messages in the network system 100, are stored in a row vector y. The number of elements e(y1) to e(yn) of the row vector y is equal to the number of messages y1 to yn generated in a chain when the initial messages x1 to xm of the sequence 1 to m are inputted.

In the present embodiment, failure in the network system 100 is detected by monitoring elements of a conversion matrix A to convert the column vector x to the row vector y. Specifically, the conversion matrix A is calculated as the product of the row vector y and an inverse matrix x̂{−1} of the column vector x. The conversion matrix A does not depend on the number or configuration of nodes in the system, and thus, does not falsely detect failure or non-failure even if the number or configuration of the nodes changes. Also, even if the number of nodes increases, the number of types of messages flowing in the network system 100 does not change, and thus, there is no increase in the number of elements in the conversion matrix A. Therefore, failure can be detected early without increasing the amount of calculation required when calculating the conversion matrix A.

<Relation between Sequence and Conversion Matrix>

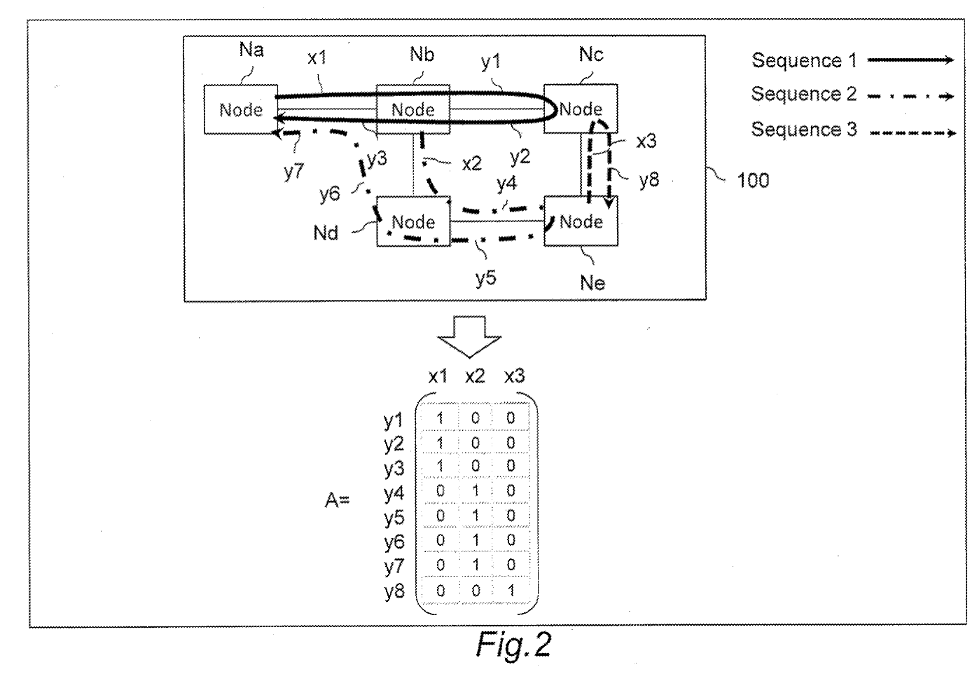

FIG. 2 is a descriptive drawing showing an example of a relationship between the sequence of traffic flowing in the network system 100 and the conversion matrix A. In FIG. 2, the sequence 1 involves starting at the message x1 from the node Na with subsequent messages y1 to y3 being successively generated and outputted to a latter stage node, and the last message y3 being inputted to the node Na. A sequence 2 involves starting at the message x2 from the node Nb with subsequent messages y4 to y7 being successively generated and outputted to a latter stage node, and the last message y7 being inputted to the node. Na. A sequence 3 involves starting at the message x3 from the node Ne with a subsequent message y8 being successively generated and inputted to the node Ne.

As an example of the sequence 1, if the node Na, which is an eNB, receives an “attach request” as an initial message from a user terminal, for example, then the node Na forwards the “attach request” as the initial message x1 of a certain sequence to the node Nb, which is an MME. Upon receipt of the message x1, the node Nb generates an “authentication information request” as a subsequent message y1 and forwards it to the node Nc, which is an HSS. Upon receipt of the message y1, the node Nc generates an “authentication information answer” as a subsequent message y2 and forwards it to the node Nb, which is an MME. Upon receipt of the message y2, the node Nb generates an “authentication request” as a subsequent message y3 and forwards it to the node Na, which is an eNB. Thus, in this sequence, the number of messages x1 and y1 to y3 is counted as 1.

The sequence 2, where the message from the node Nb is the origin, the node Nb being an MME, is simplified for ease of description, but another example of the sequence 2 is a detach sequence. In a detach sequence, first, a detach request, which is the initial message from the node Nb (MME), is transmitted to the user equipment (UE) via the node Na, and a “delete session request” is transmitted to the node Nd, which is an SGW. Upon receipt of the “delete session request,” the node Nd generates a “delete session request” and transmits it to the node Ne, which is a PGW, and the node Ne returns a “delete session response” to the node Nd. Upon receipt of the “delete session response,” the node Nd generates a “delete session response” and transmits it to the node Nb. When the node Nb further receives a “detach accept” from the UE through the node Na, it generates and transmits to the node Na a “UE context release command.” Lastly, the node Na transmits a “UE context release complete” to the node Nb, and the node Nb receives the “UE context release complete.” In this manner, the detach sequence ends.

The column size of the conversion matrix A is the number of original messages x1 to x3, or in other words, the sequence size, and the row size of the conversion matrix A is the number of subsequently generated messages y1 to y8. Elements in the conversion matrix A that have a value of “0” indicate that there is no message being transmitted. For example, regarding the value “0” of the element at the intersection of x2 and y1, the conversion matrix A does not specify which node, but indicates that even if the message x2 is inputted in the sequence 2, the message y1 is not generated.

Elements in the conversion matrix A that have a value of “1” indicate that a message is flowing normally. For example, regarding the value “1” of the element at the intersection of x2 and y6, the conversion matrix A does not specify which node, but indicates that when the message x2 is inputted in the sequence 2, the message y6 is generated.

If an anomaly has occurred in the communication state, the value v of the element becomes v<1 or v>1. Thus, monitoring the value of the elements of the conversion matrix A enables anomalies in the communication state to be detected. The value v of the element sometimes does not equal 1 due to noise or offset observation timing. Setting in advance an allowable range for the value v of the element (such as a range for v of 0.5 to 1.5 inclusive) in anticipation of such a case enables the communication state to be considered normal if the value v of the element is within the allowable range, which allows for improvement in accuracy of anomaly detection.

The normal value for the element was set as “1”, but a configuration may be adopted whereby the normal value is the average of element values over time within the same message and an allowable range for the average av (such as the average av being greater than or equal to (av−th) and less than or equal to (av+th)) is set in advance, thereby considering the communication state as normal if the element value v is within the allowable range (th is a threshold).

<System Configuration Example>

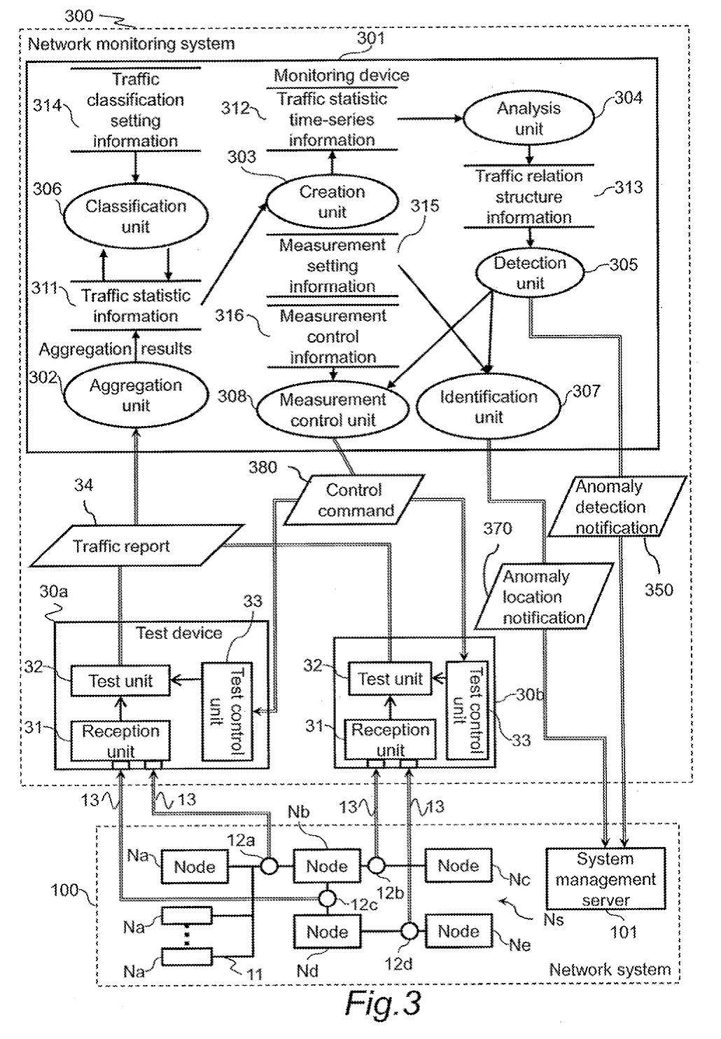

FIG. 3 is a block diagram showing a system configuration example for a monitoring system of the present embodiment. A monitoring system 300 creates a conversion matrix A by observing communication traffic within the network system 100 to be monitored, and detects communication failure in the network system 100 by monitoring the conversion matrix.

The network system 100 to be monitored has a group of nodes Ns including a plurality of nodes Na to Ne, and a system management server 100 that manages the group of nodes Ns. A plurality each of the nodes Na to Ne may be present. The node N communicates with other nodes N through the network 11. The network 11 is a computer network such as a local area network (LAN), for example. The network 11 is generally a wired LAN but may be a wireless LAN. A wide area network (WAN) may also be used. The network system 100 may include one or more network TAP devices 12a to 12d (hereinafter collectively referred to as “network TAP devices 12).

The network TAP device 12 copies packets (or frames) transmitted by the network 11, and transmits the copied packets (or copied frames) to test devices 30a and 30b (hereinafter collectively referred to as “test devices 30”) through a TAP network 13. A general LAN cable may be used for the TAP network 13. There needs to be at least one test device 30.

The network TAP device 12 may be installed in the test device 21. Alternatively, the network TAP device 12 may be installed as one function of the node N. Alternatively, the network TAP device 12 may be installed as one function of the network device such as a router or a network switch.

The communication traffic transmitted and received between the nodes N is constituted of packets to which a control protocol for controlling the respective nodes N is applied, for example. An application protocol such as Hypertext Transfer Protocol (HTTP) may be used. The messages correspond to application level data units in the communication traffic transmitted and received between the nodes N.

The message set in advance as the origin among the traffic flowing inside the network system 100 is the original message. The original message is the initial message of the sequence. The messages x1 to x3 shown in FIG. 2 are original messages, for example. A message generated from the node N that has received the original message is a generated message. A message generated from the node N that has received the generated message is also a generated message. The messages y1 to y8 shown in FIG. 2 are generated messages.

Each message has a request command as the message type. Specifically, if the request commands differ, the messages are categorized into different message types. For example, among a connection request (attach request) and a service request to the network system 100, the requested control content differs, which means that the messages are categorized into different message types. The messages x1 to x3 and y1 to y8 of FIG. 2 belong to different message types, and thus, the numbers of such messages are counted independently.

The monitoring system 300 has, respectively, one or more of the test device 30 and a monitoring device 301. The test device 30 monitors the network 11 and tests messages transmitted/received to/from the nodes N. The test device 30 has a reception unit 31, a test unit 32, and a test control unit 33.

The reception unit 31 receives copied packets from the network TAP device 12. The test unit 32 tests the content of the copied packets and transmits a traffic report including the test results to the monitoring device 301. The test control unit 33 controls the transmission interval and test items in the traffic report according to control commands (modification command or restoration command) from the monitoring device 301.

A traffic report 34 from the test unit 32 includes the measurement date and time and test results obtained by analyzing the content of the copied packets according to the test items. The measurement date and time is the date when the test items were measured. The test items include, for example, the protocol name, message type, destination IP address, source IP address, and amount of transmitted data.

The monitoring device 301 receives the traffic report from the test device 30, and, using the test results included in the traffic report, detects anomalies in the communication state of the network system 100.

The monitoring device 301 has an aggregation unit 302, a creation unit 303, an analysis unit 304, a detection unit 305, a classification unit 306, an identification unit 307, a measurement control unit 308, traffic statistic information 311, traffic statistic time-series information 312, traffic relation structure information 313, traffic classification setting information 314, measurement setting information 315, and calculation control information 316.

The aggregation unit 302 receives the traffic report 34 from the test device 30, and aggregates the total traffic statistic amount for each message type at an interval of a prescribed aggregation unit time according to the test results included in the traffic report 34, and stores the total traffic statistic amounts in the traffic statistic information 311. The traffic statistic amount is the number of messages per message type within the aggregation unit time.

The traffic statistic information 311 is a region where the traffic amount aggregate results are stored for each message type of the messages belonging to the message group, which constitutes the communication traffic. During a certain aggregation unit time, information indicating that the number of messages belonging to message type “x1” is “938” is stored, for example.

The creation unit 303 reads the traffic statistic information 311 and creates time-series data of the traffic statistic information 311, and stores the time-series data in the traffic statistic time-series information 312.

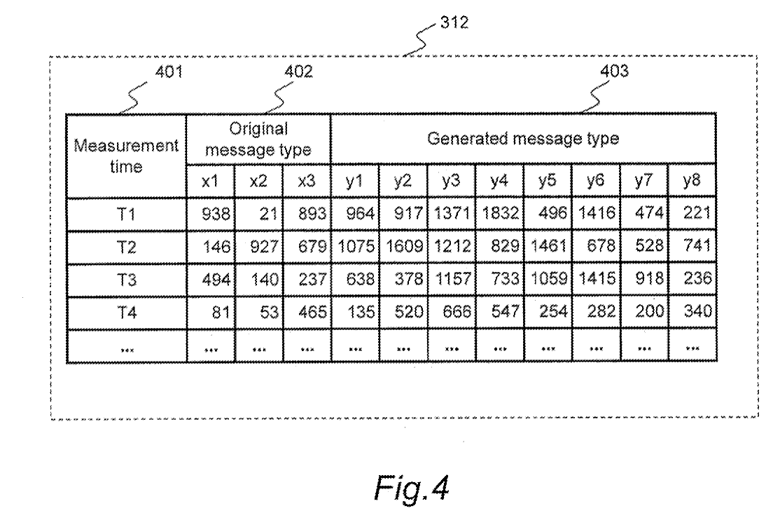

FIG. 4 is a descriptive drawing showing one example of the traffic statistic time-series information 312. The traffic statistic time-series information 312 includes measurement date and time information 401, original message type information 402, and generated message type information 403. The measurement date and time information 401 subdivides the measurement date and time included in the traffic report 34 into prescribed aggregation unit times. If the prescribed aggregation unit time is 1 minute, for example, then the aggregation unit 302 stores in the traffic statistic information 311 the number of messages where the measurement date and time recorded in the traffic report 34 is “2014/5/15 10:30:00” to “2014/5/15 10:30:59” for entries where the measurement date and time information 401 is “2014/5/15 10:30”.

The original message type information 402 is a region where the message types recorded in the traffic report 34 include the number of messages of types categorized according to the original message. The generated message type information 403 is a region where the message types recorded in the traffic report 34 include the number of messages of types categorized according to the generated message.

There are a limited number of entries for the traffic statistic time-series information 312, and thus, if all entries are used, the oldest entry may be deleted when the creation unit 303 updates the entries.

Returning to FIG. 3, the analysis unit 304 reads the time-series data for the traffic statistic amount from the traffic statistic time-series information 312, analyzes the relation between the original message and the generated message, creates the traffic relation structure data, and stores it in the traffic relation structure information 313. The traffic relation structure data is the conversion matrix A described above.

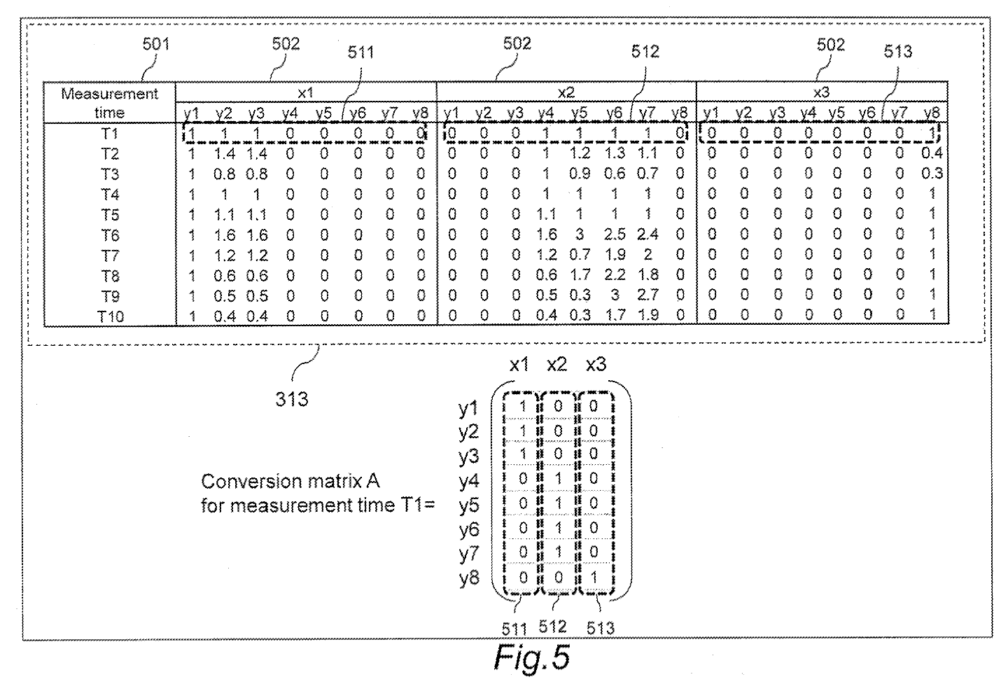

FIG. 5 is a descriptive drawing showing one example of the traffic relation structure information 313. The traffic relation structure information 313 is the traffic relation structure data, or in other words, the time-series data of the conversion matrix A described above. Specifically, with the measurement date and time T1 as an example, element arrays 511 to 513 become the column vectors 511 to 513 of the conversion matrix A.

Returning to FIG. 3, the detection unit 305 compares the current traffic relation structure data and prior traffic relation structure data, and by detecting that a change of greater than or equal to a prescribed amount has occurred, detects that an anomaly has occurred in the communication state of the network system 100. The detection unit 305 transmits an anomaly detection notification 350 to the system management server 101.

The classification unit 306 classifies the message as either an original message or a generated message with reference to the traffic classification setting information 314. The traffic classification setting information 314 is information indicating whether the message type is an original message or a generated message. The traffic classification setting information 314 is set in advance by a system manager or the like. The traffic classification setting information 314 is set such that a connection request (attach request) to the network system 100 is an original message, for example.

As another example, the traffic classification setting information 314 may have set therein a range of IP addresses of external devices of the network system 100. If the source IP address of messages included in the traffic report 34 is within the IP address range set in the traffic classification setting information 314, then a traffic classification processing unit 225 classifies the message as an original message.

The classification unit 306 and the traffic classification setting information 314 may be provided in the test device 30. In such a case, the traffic report 34 is included as a message type classified for each message by the classification unit 306.

If the detection unit 305 detects an anomaly in the network system 100, the identification unit 307 identifies where the anomaly has occurred. The identification unit 307 identifies the type of node where the anomaly has occurred using the measurement setting information 315 when an anomaly in the communication state of the network system 100 has been detected. The identification unit 307 then transmits an anomaly detection notification 370 including the type of node where the anomaly has occurred to the system management server 101.

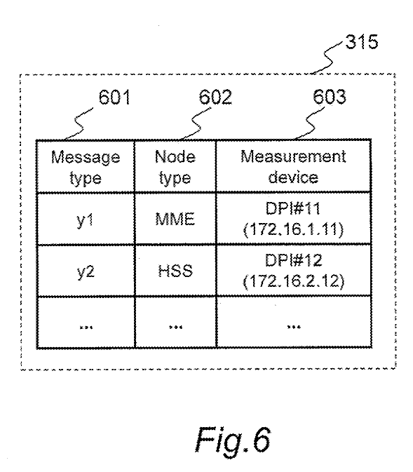

FIG. 6 is a descriptive drawing showing one example of the measurement setting information 315. The measurement setting information 315 has message type information 601, node type information 602, and test device information 603. The measurement setting information 315 is set in advance by a system manager or the like.

The message type information 601 stores the message type. The node type information 602 stores the type of node N that processes a message of a type in the same entry. The test device information 603 stores identification information that uniquely identifies the test device 30, which receives a copied message from the node N identified by the node type of the same entry. In this manner, the identification unit 307 can identify the node type and the test device 30 from the type of message detected to be anomalous by the detection unit 305 with reference to the measurement setting information 315.

Returning to FIG. 3, the measurement control unit 308 controls the test device 30. Specifically, if the detection unit 305 detects an anomaly in the network system 100, the measurement control unit 308 controls the test device 30 such that measurement performance is increased. Specifically, the measurement control unit 308 shortens the transmission interval for the traffic reports 34, for example. If the detection unit 305 detects that the communication state has returned to normal, then the measurement control unit 308 restores the measurement performance of the detection unit 30 to its state prior to the increase in performance.

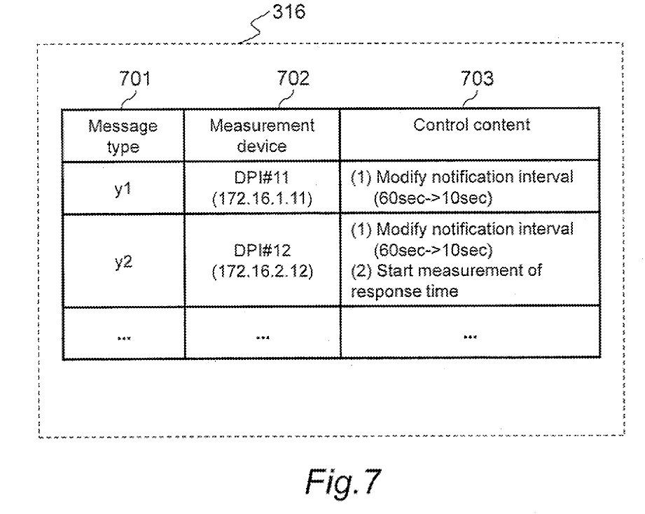

FIG. 7 is a descriptive drawing showing one example of the measurement control information 316. The measurement control information 316 has message type information 701, test device information 702, and control content information 703. The measurement control information 316 is set in advance by a system manager or the like. The message type information 701 stores the message type. The test device information 702 stores identification information that uniquely identifies the test device 30. Control content of the test device 30 identified by the measurement control information 316 in the same entry is stored in the control content information 703.

The measurement control unit 308 reads the control content from the measurement control information 316, and transmits a control command 380, which is a message including the read control content, to the test device 30 identified by the identification unit 307. The control command 380 includes, for example, a modification command to shorten the transmission interval for the traffic reports 34, and a restoration command for returning the shortened transmission interval to its original state. As a result of receiving the control command 380, the test device 30 executes a process according to the control content.

<Hardware Configuration Example>

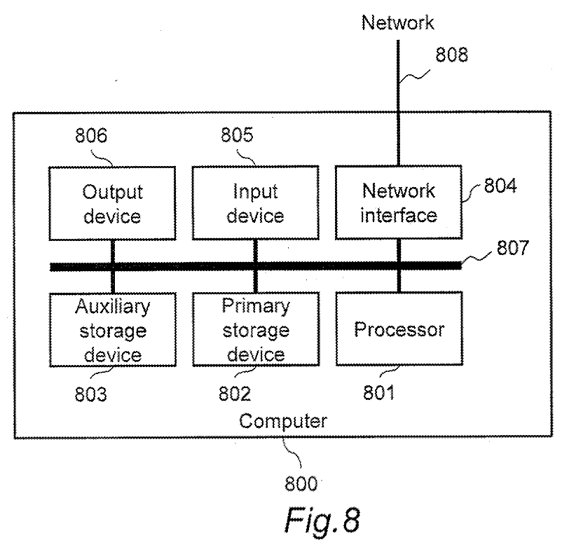

FIG. 8 is a block diagram for showing a hardware configuration example of the test device 30 and the monitoring device 301 (hereinafter, “device 800”). The device 800 includes a processor 801, a primary storage device 802, an auxiliary storage device 803, a network interface device 804 such as a network interface card (NIC) for connecting to the network 11, an input device 805 such as a mouse or keyboard, an output device 806 such as a display, and an internal communication line 807 such as a bus that connects these devices. The device 800 is realized by a general use computer, for example.

The traffic statistic information 311 can be realized by using a portion of the primary storage device 802. The device 800 loads various programs stored in the auxiliary storage device 803 into the primary storage device 802 and executes these programs in the processor 801, and as necessary, connects to the network 11 through the network interface device 804, and communicates with other devices through the network or receives packets from the network TAP device 12.

<Example of Monitoring Process Steps>

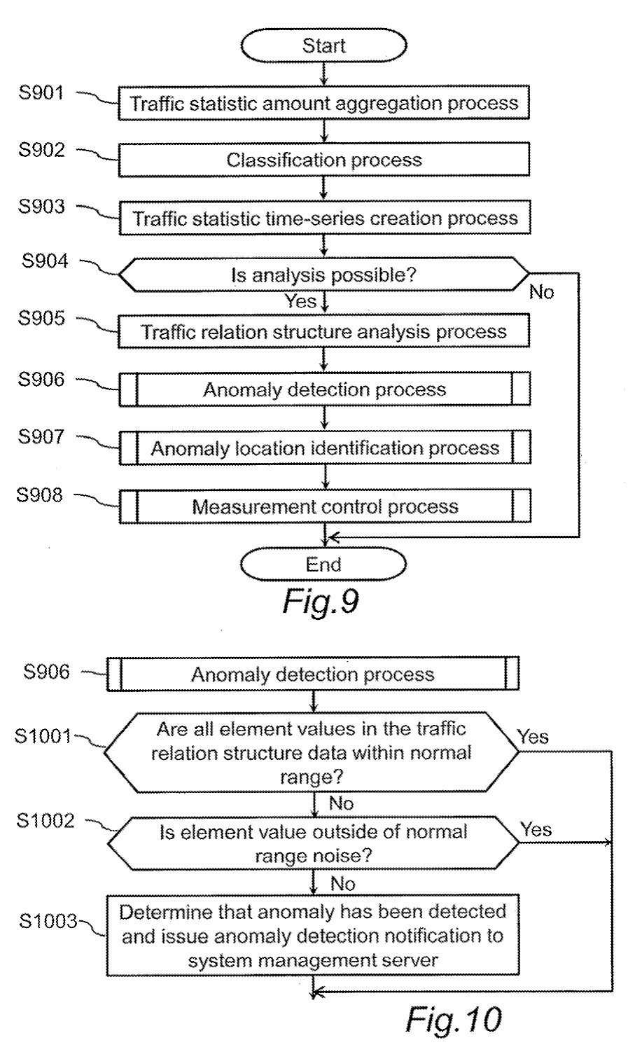

FIG. 9 is a flowchart showing an example of monitoring process steps by the monitoring device 301. First, the monitoring device 301 executes, using the aggregation unit 302, a traffic statistic amount aggregation process (step S901). Specifically, the aggregation unit 302 receives the traffic report 34 from the test device 30, and acquires test results such as test items and measurement dates and times included in the traffic report 34. The aggregation unit 302 sums up the number of messages for each message type.

Next, the monitoring device 301 executes, using the classification unit 306, a classification process in which the message is classified as either an original message or a generated message with reference to the traffic classification setting information 314 (step S902). Specifically, the classification unit 306 performs a search on the traffic classification setting information 314 with the message type as the key, and acquires information that is the classification result indicating whether the message is an original message or a generated message. The classification unit 306 adds the acquired classification results to the traffic statistic information 311. If the message type “x1” of which there are 938 messages is classified as an original message, for example, then the classification unit 306 associates “original message” with the message “x1” and the number of messages “938”, and adds this to the traffic statistic information 311.

If the classification unit 306 is provided in the test device 30, then the classification process (step S902) is not executed. In such a case, the classification unit 306 adds the classification results included in the traffic report 34 to the traffic statistic information 311.

Next, the monitoring device 301 executes, using the creation unit 303, a traffic statistic time-series creation process (step S903). Specifically, the creation unit 303 reads the traffic statistic information 311 at a fixed time interval, and creates new entries in the traffic statistic time-series information 312. The creation unit 303 then adds the statistical value for each message type to the new entry in the traffic statistic time-series information 312.

Next, the monitoring device 301 determines, using the analysis unit 304, whether traffic relation structure analysis is possible (step S904). Specifically, the analysis unit 304 determines whether enough entries for traffic relation structure analysis have accrued in the traffic statistic time-series information 312. The analysis unit 304 determines whether the number of entries in the traffic statistic time-series information 312 is greater than or equal to the number of message types classified as original messages, for example. If there are not enough entries, then analysis is impossible (step S904: No), and the monitoring process ends.

On the other hand, if there are enough entries, this means that analysis is possible (step S904: Yes), and the monitoring device 301 executes, using the analysis unit 304, the traffic relation structure analysis process (step S905). Specifically, the analysis unit 304 acquires entries of the traffic statistic time- series information 312 for which the conversion matrix A has not been created, and creates the conversion matrix A for such entries. The analysis unit 304 stores the traffic relation structure data, which is the created conversion matrix A, as a new entry in the traffic relation structure information 313.

Next, the monitoring device 301 executes an anomaly detection process (step S906), an anomaly location identification process (step S907), and a measurement control process (step S908). The anomaly location identification process (step S907) and the measurement control process (step S908) are optional. In this manner, the series of monitoring processes are ended.

FIG. 10 is a flow chart showing an example of detailed process steps of the anomaly detection process (step S906) shown in FIG. 9. The monitoring device 301 uses the detection unit 305 to refer to traffic relation structure information 313 in order to determine whether element values within the traffic relation structure information 313 are within a normal range (step S1001).

Specifically, the detection unit 305 calculates the average of past element values over a prescribed period for each message type, and by determining whether the value of the elements in the new entry has exceeded the average±threshold, determines whether the value of the elements is within a normal range. If the values of all elements in the new entry are within a normal range (step S1001: Yes), then this means that the state is normal, and the anomaly detection process ends (step S906), with the process progressing to step S907.

On the other hand, if the value of the element in the new entry is outside of the normal range (step S1001: No), then the monitoring device 301 uses the detection unit 305 to determine whether the value of the element outside of the normal range is noise (step S1002). If the value has not continuously exceeded the normal range during a fixed time until the threshold th has been exceeded, for example, then the detection unit 305 determines that the value of the element outside of the normal range is noise. The detection unit 305 may determine that the value of the element outside of the normal range is noise if the average of element values has not continuously exceeded the normal range during a fixed time until the threshold th has been exceeded.

An example of noise occurring is momentary interruption in communication due to switching of a switch hub. If the communication is momentarily interrupted but recovers within a fixed time period, then even though there was temporary noise, the communication state of the network system 100 can be determined to be normal, for example.

If the value of the element outside the normal range is noise (step S1002: Yes), then this means that the state is normal, and the monitoring device 301 causes the detection unit 305 to end the anomaly detection process (step S906), with the process progressing to step S907. The detection unit 305 may transmit to the system management server 101 a warning notification indicating that noise has occurred in the network system 100. On the other hand, if the value of the element outside of the normal range is not noise (step S1002: No), the detection unit 305 determines that there is an anomaly, and issues an anomaly detection notification to the system management server (step S1003). In this manner, the anomaly detection process (step S906) is ended and the process progresses to step S907.

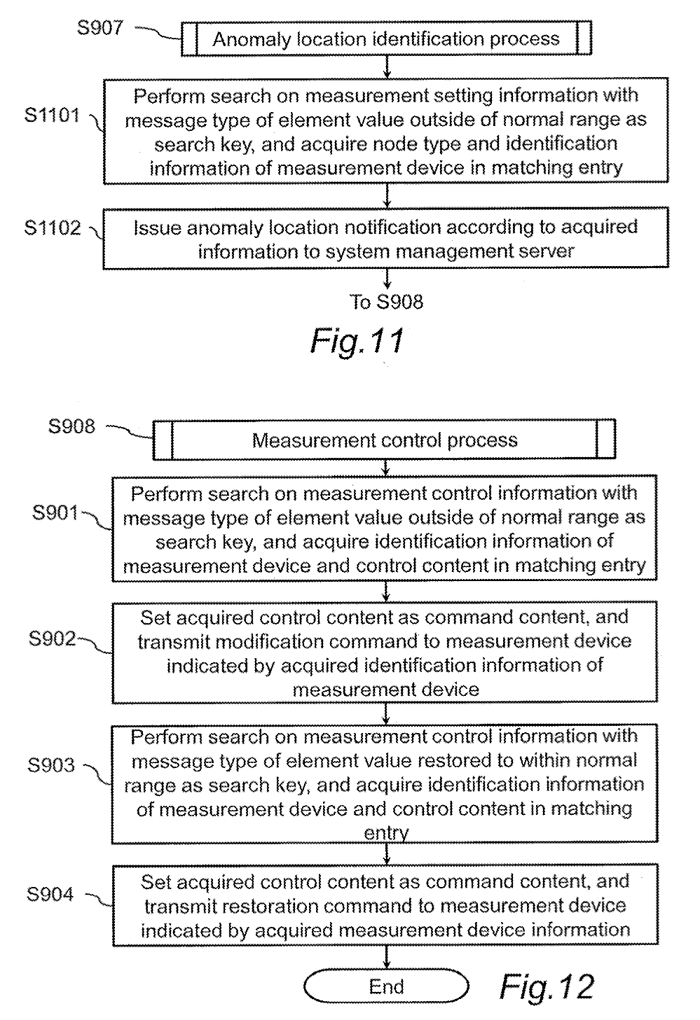

FIG. 11 is a flow chart showing an example of detailed internal process steps of the anomaly location identification step (step S907) shown in FIG. 9. The monitoring device 301 uses the identification unit 307 to perform a search on the measurement setting information 315, using as the search key the message type where the element value is outside of the normal range, and acquires information identifying the node type and test device from the node type information 602 and test device information 603 of a matching entry (step S1101). Next, the monitoring device 301 uses the identification unit 307 to issue an anomaly location notification to the system management server 101, the anomaly location being determined according to the acquired information identifying the node type and test device (step S1102). In this manner, the anomaly location identification process (step S907) is ended and the process progresses to step S908.

FIG. 12 is a flow chart showing an example of detailed process steps of the measurement control process (step S908) shown in FIG. 9. The monitoring device 301 uses the measurement control unit 308 to perform a search on the measurement control information 316, using as the search key the message type where the element value is outside of the normal range, and acquires control content and information identifying the test device from the test device information 702 and control content information 703 of a matching entry (step S1201). Next, the monitoring device 301 uses the measurement control unit 308 to set the acquired control content information 703 as command content, and transmits a modification command to the test unit 32 of the test device 30 indicated by the acquired test device information 702 (step S1202).

If a modification command in which control content information 703 states “modify transmission interval (from 60 sec to 10 sec)” is transmitted, for example, then the test device 30 uses the test control unit 33 to control the test unit 32 such that the transmission interval for the traffic reports 34 is changed from 60 sec to 10 sec. In this manner, the traffic reports 34, which had been transmitted at a 60 sec interval, are now transmitted at a 10 sec interval, enabling more detailed information to be obtained.

Also, the monitoring device 301 uses the measurement control unit 308 to perform a search on the measurement setting information 315, using as the search key the message type where the element value has recovered from being outside to being inside the normal range, and acquires the test device information 702 and control content information 703 of a matching entry (step S1203). Next, the monitoring device 301 uses the measurement control unit 308 to set the acquired control content information 703 as command content, and transmits a restoration command to the test unit 32 of the test device 30 indicated by the acquired test device information 702 (step S1203).

If, after the control content of the test device 30 is modified by a modification command in which control content information 703 states “modify transmission interval (from 60 sec to 10 sec)”, the element value has been restored to within the normal range, for example, then the monitoring device 301 uses the measurement control unit 308 to transmit a restoration command in which the control content information 703 states “modify transmission interval (from 60 sec to 10 sec)”.

The test device 30 uses the test control unit 33 to interpret the control content information 703 of the restoration command to restore the transmission interval of the traffic reports 34 from 10 sec to 60 sec. The communication traffic of the network system 100 has returned to normal, and thus, load on the test device 30 can be reduced by restoring the transmission interval of the test device 30 to the original state.

In this manner, according to the present embodiment, even in the case of a black box system in which it is difficult to identify the input/output relationship of messages between nodes within the network system 100, it is possible to detect, using test results measured by the test device 30, communication failure resulting from software faults or hardware malfunctions such as mass deletion, mass copying, or mass resending of messages.

Thus, false positives or negatives for failure detection can be reduced even if the number or configuration of nodes changes dynamically. Additionally, even in a system with a massive number of nodes such as a mobile phone system, a conversion matrix is created according to the types of messages, and thus, the size of the conversion matrix does not change even with a massive number of nodes, which enables suppression of increases in the amount of calculation and detection of failures at an early stage.

Also, it is not strictly necessary to identify the failure location or cause within the network system 100. In other words, there is no need to perform constant real time analysis of measurement values at all measurement points (network TAP device 12), and thus, it is possible to reduce calculation load due to the test device 30 and monitoring load due to the monitoring device 301. Additionally, because constant real time analysis is inefficient, detailed analysis is performed after the failure location is narrowed down to a certain extent, and thus, it is possible to improve efficiency of analysis in determining the cause of failure.

The disclosure above pertains to a representative embodiment, but a person skilled in the art would understand that various modifications and revisions can be made in form and details without departing from the gist and scope of the disclosed matter. The embodiment above was described in detail to explain the present invention in an easy to understand manner, but the present invention is not necessarily limited to including all configurations described, for example. A portion of the configuration of one embodiment may be replaced with the configuration of another embodiment. Also, a portion of the configuration of one embodiment may be added to the configuration of another embodiment. Additionally, the addition, removal, or replacement of other configurations in place of a portion of the configuration of each embodiment can be done individually or in combination.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

what is claimed is:

1. A monitoring system, comprising:
a test device that tests a plurality of messages transmitted and received by nodes in a system to be monitored, the system to be monitored having a plurality of said nodes that can communicate with each other; and
a monitoring device that monitors the system to be monitored using test results from the test device,
wherein the monitoring device executes:
an aggregation process of aggregating a number of messages for each type of message transmitted or received at the nodes using the test results received from the test device;
a classification process of classifying the respective messages, for which the numbers thereof were aggregated by the aggregation process, into either an original message that serves as an origin among messages transmitted and received by the system to be monitored, or a generated message that is generated in the system to be monitored when the original message is transmitted to any of the plurality of nodes;
an analysis process of analyzing a relationship between the original message and the generated message on the basis of a number of messages classified by the classification process as the original message and a number of messages classified by the classification process as the generated message, thereby creating a matrix indicating the relationship between the original message and the generated message; and
a detection process of determining that the system to be monitored has undergone a failure if a value of an element inside the matrix is outside of a normal range.

2. The monitoring system according to claim 1,
wherein, in the analysis process, the monitoring device creates a plurality of said matrices with differing measurement dates and times, and
wherein, in the detection process, if all values of a same element in the plurality of matrices are outside of the normal range, the monitoring device detects that a failure has occurred in the system to be monitored.

3. The monitoring system according to claim 1,
wherein the monitoring device executes an identification process of identifying a location where an anomaly has occurred by acquiring, from measurement setting information that places in association with each other a message type indicating a type of the generated message, a node type indicating a type of the node, and identification information of the test device that obtains the message from the node and tests the message, the node type of a specific node where a specific generated message corresponding to the element where the value is outside the normal range has been generated, and the identification information of the specific test device that acquires the specific generated message from the specific node and tests the specific message, if a failure has been detected in the system to be monitored by the detection process.

4. The monitoring system according to claim 1,
wherein the monitoring device executes a control process of modifying a transmission interval of test results from the test device that acquires the message from the node and tests the message, if a failure has been detected in the system to be monitored by the detection process, and
wherein, in the aggregation process, the monitoring device aggregates the number of messages for each type of message transmitted from the node in the system to be monitored on the basis of the test results by receiving the test results transmitted at the transmission interval after modification by the control process.

5. The monitoring system according to claim 1,
wherein the test device executes:
a reception process of receiving a group of messages flowing in the system to be monitored;
a test process of testing the group of messages received by the reception process to determine test results including a message type indicating a type of each message in the group of messages, a reception date when the messages were received in the reception process, and a number of the messages, and transmitting the test results at a prescribed transmission interval to a monitoring device that monitors the system to be monitored; and
a test control process of controlling the prescribed transmission interval by a control command from the monitoring device.

6. The monitoring system according to claim 5,
wherein the test device executes a classification process of classifying, on the basis of the message type, the group of messages into either an original message that serves as an origin, or a generated message that is generated in the system to be monitored when the original message is transmitted to any of the plurality of nodes, and
wherein, in the test process, the test device transmits classification results from the classification process to the monitoring device.

7. A monitoring device, comprising:
a processor that executes a program; and
a storage device that stores the program,
wherein the monitoring device monitors a system to be monitored that has a plurality of nodes that can communicate with each other, and
wherein the processor executes:
an aggregation process of aggregating a number of messages for each type of message transmitted or received at the nodes using test results received from the system to be monitored;
a classification process of classifying the respective messages, for which the numbers thereof were aggregated by the aggregation process, into either an original message that serves as an origin among messages transmitted and received by the system to be monitored, or a generated message that is generated in the system to be monitored when the original message is transmitted to any of the plurality of nodes;
an analysis process of analyzing a relationship between the original message and the generated message on the basis of a number of messages classified by the classification process as the original message and a number of messages classified by the classification process as the generated message, thereby creating a matrix indicating the relationship between the original message and the generated message; and
a detection process of determining that the system to be monitored has undergone a failure if a value of an element inside the matrix is outside of a normal range.

8. The monitoring device according to claim 7,
wherein the processor
creates a plurality of said matrices with differing measurement dates and times in the analysis process, and
in the detection process, if all values of a same element in the plurality of matrices are outside of the normal range, detects that a failure has occurred in the system to be monitored.

9. The monitoring device according to claim 7,
wherein the processor executes an identification process of identifying a location where an anomaly has occurred by acquiring, from measurement setting information that places in association with each other a message type indicating a type of the generated message, a node type indicating a type of the node, and identification information of the test device that obtains the message from the node and tests the message, the node type of a specific node where a specific generated message corresponding to the element where the value is outside the normal range has been generated, and the identification information of the specific test device that acquires the specific generated message from the specific node and tests the specific message, if a failure has been detected in the system to be monitored by the detection process.

10. The monitoring device according to claim 7,
wherein the processor executes a control process of modifying a transmission interval of test results from the test device that acquires the message from the node and tests the message, if a failure has been detected in the system to be monitored by the detection process, and
wherein, in the aggregation process, the processor aggregates the number of messages for each type of message transmitted in the system to be monitored on the basis of the test results by receiving the test results transmitted at the transmission interval after modification by the control process.

11. A test device, comprising:
a processor that executes a program; and
a storage device that stores the program,
wherein the test unit tests a system to be monitored that has a plurality of nodes that can communicate with each other, and
wherein the processor executes:
a reception process of receiving a group of messages flowing in the system to be monitored;
a test process of testing the group of messages received by the reception process to determine test results including a message type indicating a type of each message in the group of messages, a reception date when the messages were received in the reception process, and a number of the messages, and transmitting the test results at a prescribed transmission interval to a monitoring device that monitors the system to be monitored; and
a test control process of controlling the prescribed transmission interval by a control command from the monitoring device.

12. The test device according to claim 11, wherein the processor executes a classification process of classifying, on the basis of the message type, the group of messages into either an original message that serves as an origin, or a generated message that is generated in the system to be monitored when the original message is transmitted to any of the plurality of nodes, and
wherein, in the test process, the processor transmits classification results from the classification process to the monitoring device.
